(19) United States
(12) Patent Application Publication
(10) Pub. No.: US 2024/0062281 A1
(43) Pub. Date: Feb. 22, 2024

(54) Computer System and Computer-implemented Method for Matching an Affected Party with Sponsors for the Purpose of Prosecution of Legal Actions

(71) Applicant: Aequifin GmbH Und Co. KGAA, Grünwald (DE)

(72) Inventors: Stefan SCHMIDT-AMMON, Deisenhofen (DE); Frank-Martin BINDER, Dachau (DE)

(21) Appl. No.: 18/485,433

(22) Filed: Oct. 12, 2023

Related U.S. Application Data
(63) Continuation of application No. 17/266,403, filed on Feb. 5, 2021, now abandoned.

(51) Int. Cl. G06Q 30/08; G06Q 30/0279; G06Q 50/18

(52) U.S. Cl. CPC G06Q 30/08; G06Q 30/0279; G06Q 50/18

(57) ABSTRACT

The present invention relates to a computer-implemented method for matching opportunity data defining an offer for participation in a planned legal action and at least one sponsor data item defining a participation offer to participate in prosecution of a planned legal action, comprising the steps of
Providing opportunity data about the planned legal action from an affected party to a computer, wherein the opportunity data is defined by prosecution resources needed to prosecute the planned legal action, a best possible result in case of success of the prosecution and an ask participation quote,
Obtaining, at the computer, a plurality of sponsor data items each including a participation offer in a bookbuilding process wherein the participation offers each include a bid participation quote and an amount of sponsoring resources;
Using the computer, selecting one or more participation offers from the obtained participation offers depending on the ask participation quote, the prosecution resources, as well as on the bid participation quotes and the sponsoring resources of each of the plurality of the sponsor data items; and
Using the computer to automatically match the sponsor data items associated with the selected one or more participation offers with the opportunity data.

### TECHNICAL FIELD

The present invention is related to computer-implemented methods for finding cooperation opportunities between parties by processing data to balance interests in an automated manner. Particularly, the present invention relates to a matching method between opportunity data provided by opportunity providers who are willing to share and to prosecute an opportunity and sponsor data provided by parties who are willing to participate on the opportunity defined by the opportunity data by providing resources contributing to the opportunity. Particularly, the present invention relates to a computer-implemented method for matching an affected party having a legal action case on hand with a sponsoring party willing to spend resources for supporting the prosecution of the planned legal action and having the chance to participate in a successful outcome of the planned legal action.

### TECHNICAL BACKGROUND

Cooperation of entities is crucial for a successful endeavor, enterprise or venture. Often, opportunities show up which cannot be seized due to the lack of resources so that cooperation of entities is required to lead the opportunity to success. Matching the appropriate cooperating entities, however, is a difficult and time-consuming task in real life.

For instance, in the field of litigation funding, an affected party may have a potential claim which can be prosecuted by legal actions. So, the affected party may have a plan for prosecution of a legal action at hand, which may promise the specific prosecution goal such as payment of a specific amount of money (as e.g. damage compensation), claims which allow actions which have been legally prohibited so far, claims which prohibit actions by third parties, claims which require actions of governmental authorities and the like. To achieve such a prosecution goal, a funding is necessary. Therefore, prosecution costs need to be accounted for including costs such as legal attorney fees and possible costs in case of defeat. In case of low resources at the affected party, to cover these required funding resources, sponsoring partners are needed.

Matching the affected party with the sponsoring parties is usually complicated, time-consuming, non-transparent, and often depending on random parameters. Further, the sponsoring parties want to profit from a successful outcome of the planned legal action, particularly depending on the invested resources in terms of a participation quote on the result of the planned legal action. There often exists a target conflict on the participation quote by which the sponsoring party shall participate on a successful outcome of the planned legal action. So, it is the affected party's interest to keep the participation quote of the sponsoring party as low as possible. On the other hand, the sponsoring party is often only willing to invest resources if a minimum participation quote of a successful result will be guaranteed. Further, a sponsoring party may also have interest in participating in and supporting a planned legal action without any financial or commercial interest and needs to find corresponding planned legal actions.

Furthermore, matching the affected party with the sponsoring parties may require to allow that the sponsoring parties remain anonymous until the matching process has been terminated. Particularly, anonymity between the sponsoring parties should be secured.

It is known to provide a platform for sponsors to financially support legal actions. However, support is expected without commercial or financial interest so that no participation in a successful outcome is offered.

Furthermore, other funding platforms are known which offer fixed participation by purchasing shares. This allows participation on a special purpose vehicle/single purpose entity established for the legal action to be funded and under fixed conditions set by the affected party. Only the special purpose vehicle/single purpose entity has a contractual relationship with the affected party.

Therefore, a process is required which does not focus on the entities, i.e. affected party and the sponsoring parties, but on the interests embodied as opportunity data defining a planned legal action and sponsoring data items. What is needed, therefore, is an improved technique for matching opportunity data with one or more sponsoring data items for a funding of a planned legal action.

### SUMMARY OF THE INVENTION

According to the invention a computer-implemented method for automatically matching opportunity data with one or more sponsor data items according to claim 1 and a computer system according to the further independent claim are provided.

Further embodiment are indicated in the depending subclaims.

According to a first aspect a computer-implemented method opportunity data defining an offer for participation in a planned legal action and at least one sponsor data item defining a participation offer to participate in prosecution of a planned legal action, comprising the steps of:
Providing opportunity data about the planned legal action from an affected party to a computer, wherein the opportunity data is defined by prosecution resources needed to prosecute the planned legal action, a best possible result in case of success of the prosecution and an ask participation quote,
Obtaining, at the computer, a plurality of sponsor data items each including a participation offer in a bookbuilding process wherein the participation offers each include a bid participation quote and an amount of sponsoring resources;
Using the computer, selecting one or more participation offers from the obtained participation offers depending on the ask participation quote, the prosecution resources, as well as on the bid participation quotes and the sponsoring resources of each of the plurality of the sponsor data items; and
Using the computer to automatically match the sponsor data items associated with the selected one or more participation offers with the opportunity data.

Specifically, the obtaining, at the computer, of the plurality of sponsor data items may include obtaining at least one of sponsor data items in view of the previously obtained sponsor data items, wherein particularly only the bid participation quote and the sponsoring resources associated to each existing sponsor data item are indicated/revealed while other data are kept hidden/secret.

One feature of the above computer-implemented method is to automatically match opportunity data representing a planned legal action and one or more sponsor data items by means of a kind of bookbuilding system. The automated bookbuilding system uses a computer to match opportunity data provided by an affected party and sponsor data items each provided by a sponsoring party with the aim to enable the defined legal action to be prosecuted. The affected party has the plan for the legal action at hand and is allowed to offer participation in the outcome of the prosecution of the planned legal action.

The computer is configured to receive input from the affected party in form of opportunity data which represent the planned legal action. This opportunity data input indicates, apart from information about the planed legal action, an ask participation quote which defines the affected party's wish for a participation quote of sponsoring parties who want to join the planned legal action.

The computer receives input from the sponsoring parties which represent one or more bids each represented by sponsor data items containing offered sponsoring resources associated with a respective bid participation quote. The computer determines that the matching condition is met if a sufficient amount of sponsoring resources is offered associated with a bid participation quote which is equal or lower than the ask participation quote offered by the affected party. The amount of prosecution resources is initially set by the opportunity data according to the needs for prosecuting the planned legal action including all resources costs as well as the risk of failure or defeat, respectively.

The above method is implemented in an interactive computer platform which allows a facilitated negotiation between affected parties and sponsoring parties with the result to match opportunity data with sponsor data items. Further the above method allows to find an irrevocably binding equal participation quote for the affected party and the sponsoring parties. During the bookbuilding process the sponsoring parties, the source of the corresponding inputs (IP addresses of connected computers) or the like shall remain anonymous so that revealed or displayed sponsor data items cannot be associated with corresponding sponsoring parties by other sponsoring parties. The finally determined participation quote (final participation quote) defines or is related to the portion/percentage of the actual result of the prosecution of the planned legal action, which will be distributed among the sponsoring parties. The distribution between the sponsoring parties is defined by shares determined by the portion of the respective sponsoring resource on the prosecution resources needed.

Particularly, the matching of the opportunity data with multiple sponsor data items allows the requirements for enabling the planned legal action to be prosecuted to be satisfied more quickly and efficiently, because sponsoring resources from different sources can be combined. So, also participation offers providing a lower amount of resources can be matched with the opportunity data. The computer system which performs this matching of multiple sponsor data items with opportunity data is an improvement to computer technology because the computer system which performs this method automatically matches the multiple sponsor data items with the opportunity data to provide a beneficial result which was not achievable by previous computer systems. For example, embodiments of the present invention enable sponsor data items to be collected in the computer anonymously e.g. by different sponsoring parties, via different computers, via different IP addresses or the like. Moreover, existing sponsor data items may be entered or adapted in real time while all previously generated bid participation quotes and associated sponsoring resources of other valid sponsor data items can be immediately considered. So, the generation or adaptation of sponsor data items may be made depending on the existing bid participation quotes and associated sponsoring resources of all existing sponsor data items. Particularly, the bid participation quotes of other valid sponsor data items can be considered in an anonymous manner so that the adapting of the bid participation quote can be made in knowledge of the bid participation quotes of previously obtained sponsor data items but without exposing/revealing some or all other details of the source of the sponsor data item.

Furthermore, as the matching method is performed on a computer-implemented platform the information about changed ask participation quotes and the existing participation offers will be available in real time. This real-time feature of embodiments of the present invention represents an improvement to computer technology, because the computer system which enables the changed participation quotes and the existing participation offers to be available in real-time provides a result which was not achievable by previous computer systems.

Further, the participation offers may be selected from the obtained participation offers as those which have the lowest bid participation quotes which are equal or lower than the ask participation quote.

Particularly, the participation offers may be selected from the obtained participation offers as those which include associated sponsoring resources which sum up to at least the prosecution resources.

It may be provided that if more than one of the obtained participation offers of the highest bid participation quote are selectable, only the earliest participation offer is considered so that concurring participation offers will be handled on a first-come, first-served base.

Furthermore, the selecting of the participation offers may be performed after the bookbuilding process has been terminated and not before participation offers has been obtained wherein the participation offers are selected so that
the bid participation quotes associated with the selected participation offers are equal or lower than the ask participation quote, and
the total of the sponsoring resources associated with all of the selected participation offers is equal or higher than the prosecution resources.

According to a further embodiment the selecting of the participation offers may be performed after a predetermined time period after offering the planned legal action.

The best possible result after successfully prosecuting the opportunity may be an amount of resources, such as material, goods or money, the obtaining of an allowance claim or a prohibition claim, a clarification of a fundamental legal issue.

Further, the prosecution resources may include legal costs, attorney costs, all kind of legal and official fees, pre-trial costs, costs for expert opinions or appraisals, any kind of preconditions, and additional costs for an unsuccessful outcome of the planned legal action.

It may be provided that the prosecution resources, the sponsoring resources and/or the best possible result are converted into a resource unit, such as a currency or a kind of unit which make the different items of prosecution resources, the sponsoring resources and/or the best possible result resources comparable. Further, conversion process may be based on blockchain. Blockchain-based crypto currencies may be used as resource unit.

Moreover, the ask participation quote may be increased during the bookbuilding process. So, the platform may ask the affected party to adapt the ask participation quote by increasing it during the bookbuilding process.

Further, the bid participation quote may be decreased during the bookbuilding process. So, the platform may ask the sponsoring party to adapt the bid participation quote for given participation offers by decreasing it during the bookbuilding process.

According to an embodiment the platform may ask the affected party to confirm the ask participation quote, wherein after confirmation the opportunity data is stored in a blockchain based repository. So, the platform may ask the affected party to bindingly confirm the ask participation quote.

Further, the platform may ask the affected party to accept the participation offer; wherein after confirmation the opportunity data is stored in a blockchain based repository. So, the platform may ask the sponsoring party to bindingly accept the participation offer.

Particularly, prosecution of the planned legal action defined by the opportunity data may be initiated as soon as the opportunity data have been matched with the sponsor data items.

It may be provided that a share of how each of the selected sponsor data item will be associated with the actual result of the opportunity is defined by the portion of the sponsoring resource of each sponsor data with respect to the required prosecution resources.

Moreover, the planned legal action defined by the opportunity data may be initiated as soon as the opportunity data has been matched with the sponsor data items.

Further, during the bookbuilding process, a notification may be issued that the bookbuilding process will be terminated within a specific time period, such as in 24 hours, 12 hours, 6 hours, 3 hours, one hour, 30 minutes, 15 minutes, 1 minute or any other given time.

According to an embodiment, during the bookbuilding process, an interrupt may be received, wherein after receipt of the interrupt it is queried for an approval, that the interrupt has been justified, by an authorized user, wherein after receipt of the interrupt and the approval the bookbuilding process is stopped.

According to a further aspect, a method for resolving the degree of participation of sponsor data items at a planned legal action defined by opportunity data after a termination of prosecution of the planned legal action is provided; wherein an actual result of the prosecution of a planned legal action is distributed depending on a final participation quote, wherein the final participation quote is particularly defined as the highest participation quote of the selected participation offers according to above method for matching.

Moreover, an upfront share of the actual result is distributed among the sponsor data items while the remaining part of the result may be distributed among the affected party and the sponsoring parties according to the final participation quote.

According to an embodiment after providing opportunity data about the planned legal action, the opportunity data may be published on a platform and a Q & A process may be initiated, wherein the Q & A process comprises collecting, by the computer, data about questions and/or comments referring to the planned legal action within a given time period after providing the opportunity data, wherein particularly the data about questions and/or comments are anonymized and presented to the affected party, wherein it is queried for answers to the raised questions and/or clarifications to the comments of the opportunity data which will be stored and published together with the opportunity data.

According to a further aspect a computer system for matching opportunity data defining an offer for participation in a planned legal action and at least one sponsor data item defining a participation offer to participate in prosecution of a planned legal action is provided, wherein the system is configured to:
receive opportunity data about the planned legal action from an affected party, wherein the opportunity data is defined by prosecution resources needed to prosecute the planned legal action, a best possible result in case of success of the prosecution and an ask participation quote,
obtain a plurality of sponsor data items each including a participation offer in a bookbuilding process wherein the participation offers each include a bid participation quote and an amount of sponsoring resources;
select one or more participation offers from the obtained participation offers depending on the ask participation quote, the prosecution resources, as well as on the bid participation quotes and the sponsoring resources of each of the plurality of the sponsor data items; and
automatically match the sponsor data items associated with the selected one or more participation offers with the opportunity data.

According to a further aspect a computer program product is provided comprising a computer usable medium having computer readable program code means embodied in said medium for causing an application program to execute on a computer a computer-implemented method for matching opportunity data defining an offer for participation in a planned legal action and at least one sponsor data item defining a participation offer from a sponsoring party to participate in prosecution of a planned legal action, wherein the application program performs the steps of:
Providing opportunity data about the planned legal action from an affected party to a computer, wherein the opportunity data is defined by prosecution resources needed to prosecute the planned legal action, a best possible result in case of success of the prosecution and an ask participation quote,
Obtaining, at the computer, a plurality of sponsor data items each including a participation offer in a bookbuilding process wherein the participation offers each include a bid participation quote and an amount of sponsoring resources;
Using the computer, selecting one or more participation offers from the obtained participation offers depending on the ask participation quote, the prosecution resources, as well as on the bid participation quotes and the sponsoring resources of each of the plurality of the sponsor data items; and
Using the computer to automatically match the sponsor data items associated with the selected one or more participation offers with the opportunity data.

Other features and advantages of various aspects and embodiments of the present invention will become apparent from the following description and from the claims.

### BRIEF DESCRIPTION OF THE DRAWINGS

Embodiments are described in more detail in conjunction with the accompanying drawing in which:

FIG. 1 shows an exemplary client-server architecture in which the bookbuilding process shall be applied;

FIG. 2 shows functions of the server system in the client-server architecture of FIG. 1;

FIG. 3 shows components used in the bookbuilding method and the relationship among these components;

FIG. 4 shows a flowchart describing the matching process for opportunity data;

FIG. 5 shows a flowchart describing the matching process for a sponsoring party;

FIG. 6 shows a flowchart for the method for obtaining a result of the matching process.

FIG. 7 shows a flowchart of the process of sponsor protection.

FIG. 8 shows a flowchart of the process of interrupting the bookbuilding process.

### DETAILED DESCRIPTION

Embodiments of the present invention provide a computer-implemented platform for matching opportunity data provided by an affected party and sponsor data items provided by sponsoring parties to establish a match for a cooperation e.g. for commonly prosecuting a planned legal action. The opportunity data and the sponsor data items shall be matched to enable prosecution of the planned legal action with common resource funding.

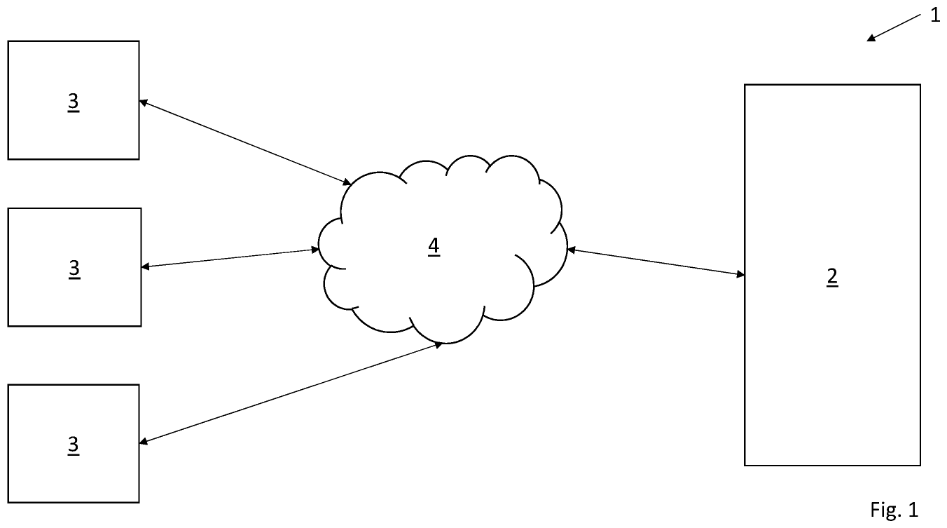

The matching occurs when offers in terms of total resource requirements for a maximum ask participation quote are satisfied by sponsoring resources funded by sponsoring parties and associated bid participation quotes related to the one or more sponsoring resources offered. The matching platform may be implemented on a client-server architecture 1 as shown in FIG. 1.

In the following the process is described in detail with respect to a litigation funding process wherein the opportunity provider may be a lawyer having an affected client with one or more legal claims which needs to be enforced by legal actions. The lawyer and the client (potential plaintiff, rights owner) may form an affected party. Due to a lack of funding for prosecution, the affected party (opportunity provider) as a potential plaintiff may agree that his or her case is entered into the opportunity database and a bookbuilding process is started as described in more detail below.

As shown in FIG. 1, the client-server architecture 1 comprises a server system 2 and a plurality of client systems 3 interconnected by various communication networks 4. In the context of the communication networks like the Internet, essentially the server system 2 acts as a service and resource provider and each client can make a request for the service or resources from its client system 3. The present platform is hosted in that server system 2, and the service can be requested by anyone and data can be provided through the client system 3. The following description will detail the functions of the server system 2 providing services to individual entities including affected parties and sponsoring parties which operate the client systems 3.

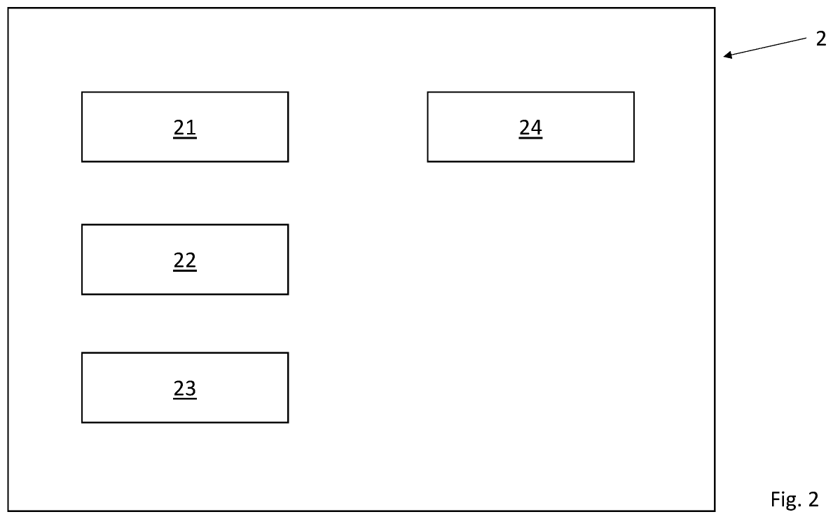

As shown in FIG. 2, the functions of the server system 2 are implemented as software which basically includes server applications and databases. The databases include an opportunity database 21, an opportunity provider database 22, and a sponsoring party database 23. Furthermore, the server system 2 provides a microprocessor 24 as part of a computing system which performs a server application to establish the functionality of the matching method as described in detail below. Furthermore, the microprocessor 24 may implement or include a webserver so that a webpage may be used as a carrier of the information and data. The server application running on the microprocessor 24 is the core of the server system 2. It can execute the commands to query and retrieve the databases at a users request and create the webpage containing the information and the data requested by the user and return it to the user.

The client system 3 may execute a web browser program, the browser exchanges information with the server system 2 for the client and provides the local service. It can send requests and data to the server system 2 and can display a webpage containing resulting information provided by the server system 2. The web browser allows the user to enter an address to direct to the server system 2.

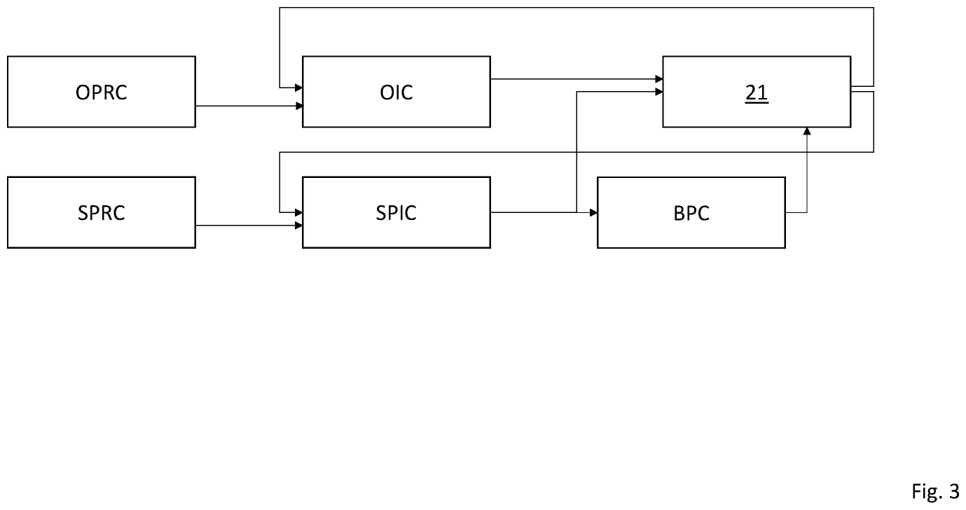

The client system 3 and the server system 2 may provide software components to implement a bookbuilding method which is described in detail below. The components used in the bookbuilding method and the relationship among these components are illustrated in FIG. 3 in detail. The components include: an opportunity provider registration component OPRC, an opportunity input component OIC, a sponsoring party registration component SPRC, a sponsoring party input component SPIC, and a bidding processing component BPC.

The opportunity provider registration component OPRC enables an opportunity provider to register to use the platform. The registration procedure is commonly known for Internet services wherein the user is required to create an opportunity provider ID and a password and to provide the necessary information about the opportunity provider including personal and address data. Information about registered opportunity providers will be stored in the opportunity provider database 22. It has to be ensured that the identity of the user is authorized as the offers of the opportunity providers made on the platform shall be binding.

The same is true for the sponsoring party registration component SPRC which requires a registration of the sponsoring party to use the system by means of a registration procedure. The registration procedure for the sponsoring parties is also commonly known for Internet services wherein every sponsoring party is required to create a sponsoring party ID and a password and to provide the necessary information about the sponsoring party including personal and address data. Information about the registered sponsoring parties will be stored in the sponsoring party database 23. It has to be ensured that the identity of the sponsoring party is authorized as the offers of the opportunity providers made on the platform shall be binding.

Once registered, the affected party may log into an opportunity provider area of the opportunity input component OIC which corresponds to a restricted set of functions associated to entering opportunities of planned legal actions into the opportunity database 21. The opportunity provider area provides one or more screen forms to query for some inputs which are described in detail below.

In the present embodiment, the opportunity is defined by opportunity data and may relate to a planned legal action which involves an uncertain outcome.

Furthermore, together with the opportunity, opportunity data defines the best possible result to be expected after successfully prosecuting (full success) the legal action. The best possible result may be an amount of resources, such as material, goods or money, the obtaining of an allowance claim or a prohibition claim, and a clarification of a fundamental legal issue. Any kind of costs to achieve the best possible result shall be considered. Furthermore, the computer receives input from the affected party which is represented by the opportunity data including a detailed description including valuable documents containing essential information describing and concerning the planned legal action including facts, evidence and planned timeline etc., which allow a third party, i.e. sponsoring parties, to make their own assessments about the likelihood of success for the planned legal action. In addition, the affected party indicates a requirement of resources needed as a funding for prosecuting the legal matter as well as an ask participation quote by which further sponsors may be allowed to participate on a positive result of the prosecution.

Moreover, after registration, the sponsoring party may enter a sponsoring party area of the sponsoring party input component SPIC which corresponds to a restricted set of functions in which the sponsoring party can select interesting opportunities, such as planned legal actions, and place participation bids by entering a bid participation quote and sponsoring resources indicating the degree of participation on the planned legal action. The sponsoring party area provides screen forms to query for inputs which are described in detail below.

By means of the bid processing component BIC, the entered opportunity data and the corresponding bid information are processed by the platform to obtain a match between the affected party and one or more sponsoring parties depending on the opportunity data including the ask participation quote and, for each of the sponsoring parties, the bid participation quote and the information.

Furthermore, via the opportunity provider input component OIC, it may be enabled to modify the opportunity data, as long as the matching process has not been finished. Particularly, the ask participation quote of the opportunity data may be increased, but may not change the offered opportunity otherwise. Usually, the amount of prosecution resources needed to prosecute the legal action must not be changed by the affected party once input in the database or even after the bookbuilding process has been started.

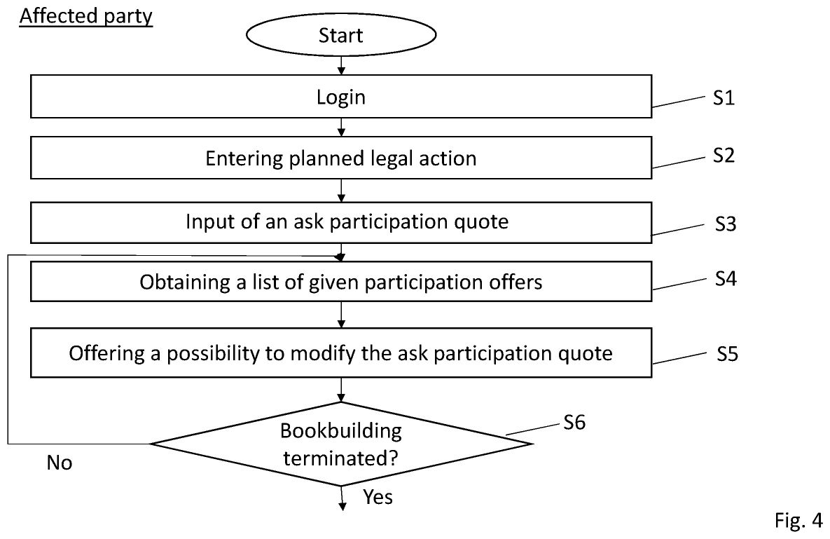

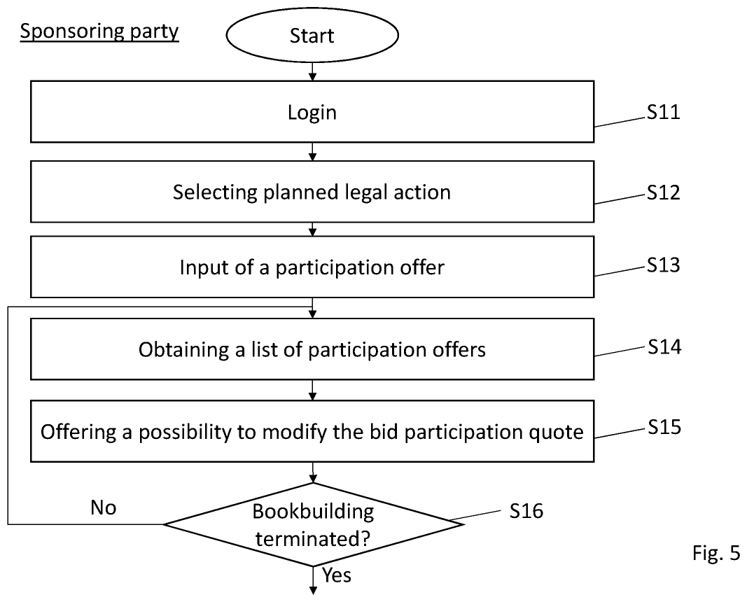

The bookbuilding process is described in more detail below in conjunction with the flowchart of FIGS. 4 and 5. The flowchart of FIG. 4 shows the process for providing opportunity data.

In step S1 the platform may request a member of an affected party to login into the opportunity provider area.

Furthermore, in step S2, opportunity data representing a planned legal action, such as a planned litigation suit or the like (opportunity), the best possible result and an amount of prosecution resources necessary to prosecute the planned legal action to permit obtaining the best possible result may be entered by the affected party. The prosecution resources may include legal costs, attorney costs, pre-trial costs, costs for expert legal opinions or appraisals, any kind of preconditions and the like. The prosecution resources may also include additional costs for an unsuccessful result of the legal action such as costs for a defeat including cost reimbursements to the opponent of the proceedings. In other words, any risks or potential losses of the legal endeavor are also covered by the prosecution resources.

These kinds of prosecution resources as well as the best possible result may be evaluated by means of a resource unit which may be a currency, blockchain-based tokens, crypto-currencies or any other kind of unit which make the different items of prosecution resources comparable. The total of the prosecution resources may indicate the funding needs, and the best possible result the best possible chance for success.

In step S3, an ask participation quote as an initial information is input by the affected party via the platform which may form part of the opportunity data. This initial information may represent an offer of the affected party and starts a bookbuilding process which invites sponsoring parties to participate in the full success of the planned legal action.

The ask participation quote may indicate the currently maximum quote of participation for the best possible result of the planned legal action. Consequently, while the prosecution resources indicate what is necessary for starting prosecution of the legal action, e.g. to cover all financial risks, the ask participation quote indicates the return on investment offered by the affected party if the prosecution of the legal action will be fully successful. Of course, the result of the legal action can be all or nothing, or can also partially correspond to the best possible result of the legal action (partial success). The ask participation quote is considered as 0, if no ask participation quote is entered or no participation of the possible result of the legal action is offered by the affected party.

After the case of the planned legal action has been input by the affected party, it may be stored in a database and made ready for retrieval by potential sponsors. In a preferred embodiment the planned legal action of the affected party will be considered as an offer and stored in a blockchain based database such as “Ethereum” for generating a smart contract.

In step S4, a list of existing bid participation offers (bids) may be displayed or output otherwise. The list may contain representations of one or more sponsor data items (to be described in detail below) including information or offers to signalize the wish of financial support of/financial participation at the legal action by providing sponsoring resources. The sponsoring resources indicate a specific bid of resources which shall participate needed for prosecuting the legal action. The sponsoring resources may be associated/combined with a bid participation quote which corresponds to a currently minimum participation for which the offer shall be valid. The list may be anonymized so that only the existence of a sponsor data item with an indication of the sponsoring resources and bid participation quote associated therewith may be revealed to the affected party but not the identity of the sponsoring party.

In step S5, the affected party may in view of the displayed list of existing bid participation offers have the option to increase the ask participation quote. This may be carried out automatically or manually as a result of a user query provided by the computer. Particularly, it is enabled to adapt the ask participation quote in view of all of the sponsor data items provided by the sponsoring parties, e.g. to make the legal action more attractive for possible sponsoring parties or to enable more already existing sponsor data items to be matched with the opportunity data of the planned legal action.

In step S6, it is checked by the computer/platform if the bookbuilding process is terminated. If it is determined that the bookbuilding process is terminated the method is continued by step S21 otherwise it is continued with step S4. Substantially, it is checked whether a predefined termination condition (as explained below) has been met.

The flowchart of FIG. 5 shows the bookbuilding process for providing sponsor data items.

In step S11 the platform may request a sponsoring party to login into the sponsoring party area.

The process of bidding is started and it is collected sponsor data items taking into account all necessary information about existing planned legal actions including the changes for best possible result, the required prosecution resources and the current ask participation quote. So, in step S12, existing opportunity data is selected among the different opportunities representing planned legal actions. This may be performed by browsing through a list of corresponding items indicating different planned legal actions/litigation cases.

In step S13, one of the planned legal actions may be selected by a sponsoring party associated with one of the opportunity data and a participation offer is entered as a sponsor data item. The participation offer may include an amount of sponsoring resources provided to support the planned legal action for a possible match. Together with the sponsor data item an amount of sponsoring resources (or resource units) may be received which indicates the portion of participation on the selected planned legal action. The resources to be spent can be an amount of investment (money), existing claims, consultation effort, workforce, material and the like. These sponsoring resources may be converted into the resource unit which is identical to the resource units used with the opportunity data to make the needed prosecution resources comparable.

Further, the participation offer includes a bid participation quote which corresponds to a validity threshold of the participation offer. The validity threshold indicates a lowest acceptable participation quote.

The sponsoring party has the choice to offer a bid participation quote of 0. Also if no bid participation quote is given, then the bid participation quote will be set to 0.

A bid participation quote of 0 means that the sponsoring party accepts that they may receive no return for participating on the planned legal action according to their participation offer or that the matching with the opportunity data shall involve no participation. A sponsoring party may have interest in such an option if a positive outcome of the planned legal action is useful for the sponsoring party in another than financial aspect. For instance, the sponsoring party may only have interest in a legal decision of prosecuting the planned legal action as case law may be generated which may help the respective sponsoring party for own endeavors.

The offer represented by the sponsoring party is legally binding so that if it turns out that the final ask participation quote is equal or higher than the bid participation quote, the sponsoring resources (according to the bid participation quotes) must be provided/delivered/paid to the affected party once the bookbuilding process has been finished. On the other hand as the opportunity data also represent a binding opportunity offer it is agreed to the participation quote of the participation offer.

After participation offer has been input by the potential sponsoring provider, it may be stored in a database. In a preferred embodiment the participation offer of the sponsoring party will be considered as an acceptance of the offer of the affected party and stored in a blockchain based database such as “Ethereum” for generating a smart contract. The contract is potentially valid once the final ask participation quote is equal or higher than the bid participation quote.

In step S14, a list of given participation offers of other sponsoring parties is retrieved wherein the sponsoring parties are anonymized so that confidentiality is ensured.

In step S15, the bid participation quote of the sponsoring parties may be modified, particularly decreased. This may be carried out automatically or manually as a result of a user query. Particularly, it is enabled to adapt the participation quote in view of the existing participation offers represented by other sponsor data items. In this case the existing participation offers are anonymized so that only sponsoring resources and associated bid participation offers are indicated.

In detail, before, while and/or after a sponsor data item has been received from a sponsoring party, the return on investment may be displayed for a full success of the planned legal action and one or more exemplary partial successes. So, the sponsoring parties always have the chance to see a display of existing bids indicating the sponsoring resources offered and the associated bid participation quote. It will be indicated in the table which bids may contribute to the requirements of the planned legal action in terms of having a bid participation quote of each of the sponsor data items equal or lower than the ask participation quote. Due to the possibility of modification of the bid participation quotes of each of the sponsor data items, a bookbuilding process is performed which allows to render an unconsidered bid considered by lowering the corresponding bid participation quote.

In step S16 it is checked if the bookbuilding process is terminated. If it is determined (option: yes) that the bookbuilding process is terminated the method is continued by step S21 otherwise (option: no) it is continued with step S14. Substantially, it is checked whether a predefined termination condition has been met. The termination condition may include: that a predetermined amount of time has elapsed since start of the bookbuilding process by entering the corresponding opportunity data and/or that the bookbuilding process has been successful, i.e. the necessary amount of sponsoring resources needed for prosecuting the planned legal action has been offered with bid participation quotes equal or lower than the ask participation quote, could be collected, and/or the affected party declares that the bookbuilding is closed.

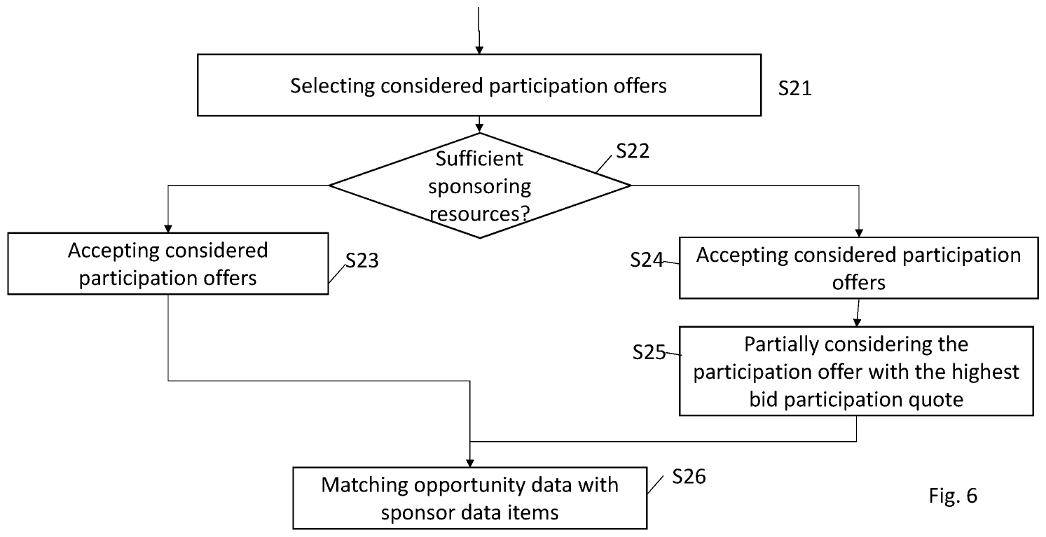

The flowchart of FIG. 6 shows the process after termination of the bookbuilding process for sponsoring parties.

When it has been determined that the bookbuilding process was successful, in step S21 only those of the collected participation offers including the associated sponsoring resources (amount of resource units) and the associated bid participation quote are considered where the corresponding bid participation quotes are equal or below the ask participation quote. Considering the bid participation quotes render the potentially valid contract to a valid contract.

In step S22, it is checked whether the total of the considered sponsoring resources is sufficient for the funding needs. If, in step S22, it is determined that the total of the sponsoring resources e.g. in terms of the resource units associated with the considered participation offers is equal to the funding needs, all considered participation offers are accepted in step S23. If in step S22 it is determined that the total of the resource units associated with the considered participation offers is higher than the funding needs, the participation offers including the lowest bid participation quote will be considered first until the amount of resource units corresponding to the prosecution resources is reached or exceeded. For instance, the participation orders may be ordered in a list with increasing bid participation quotes and the sponsoring resources will be added for each item from top downwards to the list of considered participation offers until the required prosecution resources are reached or exceeded.

The participation offer considered in step S24 with the highest bid participation quote may be only partially considered in step S25 if the amount of resource units corresponding to the prosecution resources is exceeded. In case there are more than one participation offers of the highest bid participation quote only the earlier participation offer(s) is(are) considered in step S25. So, in case of concurring participation offers having the same bid participation quote, the bids will be handled on a first-come, first-served base so that the latter participation offer(s) will be neglected or at least partially neglected.

All considered participation offers will now be used for matching the opportunity data with the sponsor data items referred to the considered participation offers. Accordingly, for instance, the considered participation offers may be used to finance/support/prosecute the planned legal action in step S26 according to a final participation quote which corresponds to the highest participation quote of the considered participation offers. The portion of each sponsor data item in terms of financing/support/prosecution is defined by the portion of the (considered part of) sponsoring resources of each sponsor data item with respect to the required prosecution resources. This portion substantially may represent a share of how the sponsor data item will be associated with the actual result of the planned legal action.

The possibility that the participation quote is modified/changed during the bidding process at any time allows finding an optimal participation quote for both the planned legal action represented by the opportunity data and the offers represented by the sponsor data items through the computer-based quote balancing mechanism as described above.

During the bookbuilding process, notifications can be issued, e.g. by email, that the bookbuilding process will end within a specific time period, such as in 24 hours, 12 hours, 6 hours, 3 hours, one hour, 30 minutes, 15 minutes, 1 minute or any other given time so that the bid participation quotes can be modified if necessary.

After the bookbuilding process has been finished and the matching between the opportunity data and the sponsor data items has been fully prosecuted, equal participation quotes are applied on the result of the prosecution of the planned legal action according to the highest participation quotes of all considered participation offers (bids).

In the event that it turns out that the prosecution costs are not sufficient to fully prosecute the planned legal action, the sponsoring parties have the right of first option to supplement the biddings by increasing the sponsoring amount. Consequently, the sponsoring amount can be increased. Therefore, it is queried whether the sponsor data item shall be changed by increasing corresponding sponsoring amount. Particularly, the sponsoring parties may be informed and asked to supplement the bidding and/or a call for additional sponsoring parties on the platform will be made. This can be in the form of a new bookbuilding process where the prosecution resources will be the additional resources needed. Existing and additional sponsoring parties may place participation offers including sponsoring resources and bid participation quotes.

In order to compensate the sponsoring parties in the case where the prosecution goal has not been achieved or not fully been achieved, i.e. where the result of the legal action stays below the expected success, the prosecution success may be distributed in an adjusted manner. So, the sponsoring parties may benefit from an adjusted distribution of the prosecution success. This procedure shall protect the investment of the sponsoring parties and is called herein sponsor protection. Here, the return on investment for the sponsoring parties may be set to have a higher priority than the success of the affected party. This may help to motivate the affected party who is responsible for prosecution of the planned legal action to keep on with prosecution of the planned legal action as there will be a return only with a higher success rate.

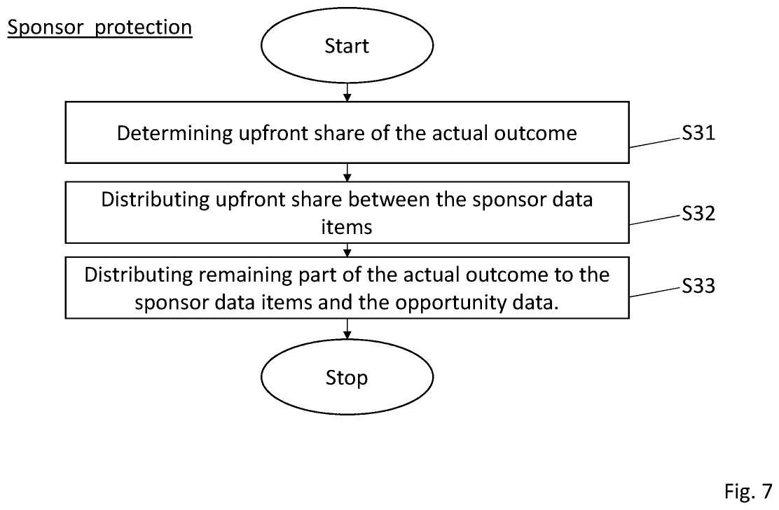

The process of sponsor protection is illustrated by the flowchart of FIG. 7.

Sponsor protection can be achieved by associating an upfront part of resources/amount of resource units to the sponsor data items before a remaining part of resources resulting from the prosecution success is associated to the opportunity data and the sponsor data items in a distributed manner. Resources associated to the opportunity data or sponsor data items might by refunded to the respective user or origin of the data or data item.

For sponsor protection, the sponsoring parties shall benefit from an adjusted distribution of the result of the prosecution of the planned legal action.

This is accomplished by associating an upfront share of the actual result of the prosecution (upfront share) in step S31 which is determined depending on an upfront quote. The upfront quote determines the portion of the actual result to be distributed among the sponsoring parties first before the remaining portion of the actual result is distributed among each of the sponsor data items and the opportunity data. The upfront quote may be determined depending on the actual result of the prosecution and the best possible result, such as e.g.:

Upfront quote=1−(actual result/best possible result)

Substantially, the upfront share as e.g. determined by

Upfront share=Upfront quote×prosecution resources

is commonly associated to the considered sponsor data items e.g. for distribution among the sponsoring parties.

In step S32, this upfront share is shared between the sponsor data items according to the portion of the respective sponsoring resources with respect to the total of considered sponsoring resources which equals the required prosecution resources.

In step S33, after associating and sharing the upfront part of the actual result the remaining part of the actual result (which is the difference between the actual result and upfront share), if any, is commonly associated to the sponsor data items and the opportunity data.

Portions and shares as indicated above may be calculated on the basis of resource units.

Following to the upfront distribution of the upfront share to the sponsoring parties the remaining portion of the actual result (actual result−upfront share) is associated according to the final participation quote. This distribution is made according following scheme:

Opportunity data:(1−final participation quote)×(actual result−upfront share)

For each sponsor data item, the portion of actual result will be depending on the associated sponsoring resources:

Upfront distribution for each sponsor data item:

upfront share×sponsoring resources/prosecution resources

Distribution of remaining part for each sponsor data item:

final participation quote×(actual result−upfront share)×sponsoring resources/prosecution resources

Particularly, the upfront share and the distribution of the remaining part can be interpreted as a degree of participation of the sponsor data items at the actual result.

The afore-described matching method can be well applied to a litigation funding process wherein the affected party may be a lawyer having a client (plaintiff) with a legal claim which needs to be enforced by court. Due to a lack of funding for prosecution, the affected party as a potential plaintiff may agree that his case is entered into the opportunity database and a bookbuilding process is started. While entering the planned legal action case into the database, the lawyer calculates the maximum costs of the proceedings including risks which corresponds to the funding needs, and the prosecution goal which may correspond to the best possible result of the prosecution of the planned legal action under full success. The prosecution costs are then open to be covered by the bookbuilding process.

Now it is up to the lawyer/client (affected party) to decide about the ask participation quote, i.e. the participation quote the client is willing to offer for the sponsoring parties in case of success. For litigation funding, the prosecution resources may be mainly requested as amount of money which in this matter may correspond to the resource unit. However also other kind of resources may be required as well such as individual legal claims, workforce or the like.

The sponsoring party may be informed by browsing the opportunity database of the open opportunity for planned legal actions and are invited to enter bids for an amount of money they want to invest associated to a bid participation quote they can choose. The ask participation quote entered by the affected party, however, determines whether the bid of the sponsoring party is in or out, i.e. contributing to the litigation funding or not, depending on the given ask participation quote.

Once the bookbuilding process has been terminated and the legal action has been fully prosecuted, an equal final participation quote is applied on the result of the prosecution of the planned legal action according to the highest participation quotes of all considered participation offers.

As an alternative embodiment, a kind of interrupt may be provided that may be activated during the bookbuilding processes of steps S1 to S6 and S11 to S16. The computer may therefore provide a switch, e.g. in form of a button or the like on the platform, which can be activated by either by the affected party and/or the sponsoring parties, or by a subset thereof which has been qualified to request for an interrupt of the bookbuilding process.

The interrupt may be used to protect all users of the platform and to reduce the risks for the planned legal action to be prosecuted after the book-building processes have been successfully terminated. The option to interrupt the book-building process may be required if new facts appear which may influence the assessment of the chances of the outcome of the planned legal action or which may increase the prosecution costs when conducting a lawsuit. New facts can include new case law, new laws and regulations, an offer for an amicable settlement which the affected party intends to accept, suspect of fraud, substantial neglect or breach of duty, other facts which may affect the funding contract, facts which may lead to an economic disadvantage for other sponsoring parties such as bankruptcy of one of the sponsoring parties, facts which may require the need for a new assessment of the case such as any knowledge about that one of the sponsors has insider information which may result in disadvantages of other sponsoring parties, suspect of money laundering und criminal activities, obvious faults at the calculation of the sponsoring resources and the like.

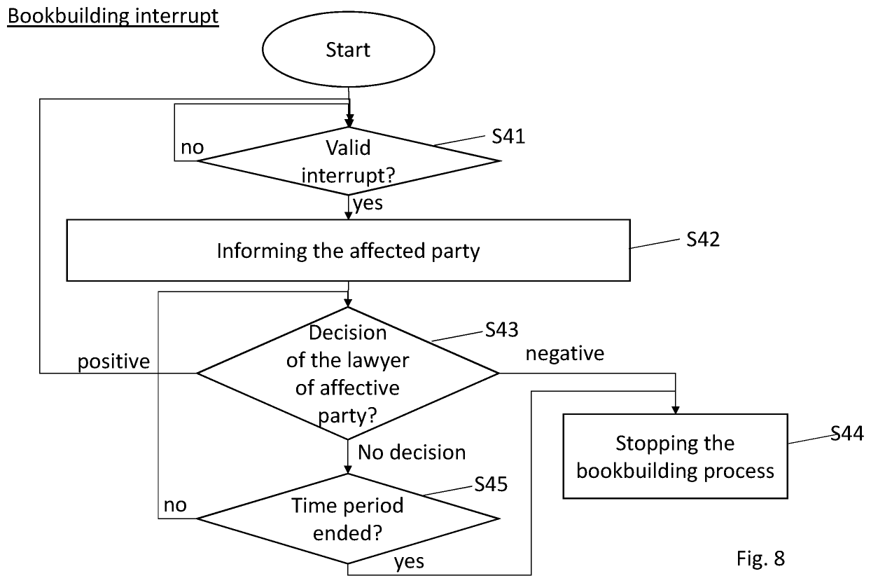

FIG. 8 shows a flowchart illustrating the handling of such an interrupt caused by one of the users of the platform. In step S41, it is checked whether an interrupt has been activated by an authorized user. Authorized users can be any user of the platform including a member of the affected party and the sponsoring parties or only qualified users included in the affected party and sponsoring parties.

For instance, the affected party may include a claim owner and a lawyer who assessed the case of the claim owner and entered the case into the platform. Here, it may be provided that only the lawyer is allowed to activate the interrupt of the bookbuilding process while the claim owner who has usually no insight into the legal aspects of the case will be not allowed to activate the interrupt. The interrupt may be activated by providing a virtual button or the like on the platform. The acceptance of the activation of the interrupt by the platform may require the input of reasons for interruption of the bookbuilding process. This can be queried by providing an input possibility of a checklist and/or a text input field so that the acceptance of the interrupt is only made if a reason is given by the user who wishes to interrupt the bookbuilding process.

The interrupt subroutine is continued with step S42 if the interrupt is activated including the indication of a reason for interruption (Alternative: yes). Otherwise (Alternative: no) it is waited for an interrupt in step S41. In step S42, the affected party respectively the lawyer of the affected party corresponding to the opportunity data is informed. For instance, an email can be sent to the lawyer informing that the interrupt has been activated, furthermore a time period is set which indicates a point of time in the future where the bookbuilding process will be automatically terminated unless the lawyer of the affected party decides that the bookbuilding process shall be continued.

In step S43 it is checked if the lawyer decides to continue the bookbuilding process or to stop the bookbuilding process. If the attorney does not make any decision, this process is continued with step S45. In step S45, it is checked whether the time period has ended. If this is the case (alternative: Yes), the process will be continued by step S44, otherwise it is continued to step S43.

In step S43, if it is determined that the bookbuilding process shall be continued, the processes of steps S1 to S6 and S11 to S16 will be continued and the interrupt subroutine will be continued with step S41 waiting for a next interrupt. If in step S43 it is determined by the lawyer that the bookbuilding process shall be stopped, in step S44 the bookbuilding is stopped and information will be sent to the sponsoring provider and the sponsoring parties that no contract has been made.

As an optional feature, if the lawyer decides that a bookbuilding process shall not be stopped as the activation of the interrupt has been fraudulent, misuseful or because of an undue or non-justified reason, the user who has triggered the interrupt of the bookbuilding process may be excluded from access to the platform, may be excluded from participation of the same legal action or will be charged with a penalty, such as a specified amount of money or any kind of resource unit.

Once the bookbuilding process has been stopped, it cannot be continued and has to be newly entered into the database or set active to be started again. If the bookbuilding process for the same planned legal action is started again, an indication can be displayed that it is a case which had been interrupted before.

It may be provided that after step S2 wherein the affected party entered opportunity data about the planned legal case a Q & A process is initiated. The Q & A process may be provided to inform potential sponsors about additional information about the planned legal action by allowing them to ask own questions. In a first phase, which may be a given time period after the opportunity had been firstly entered into the database, all users of the platform are allowed to enter questions and comments to a planned legal action presented by the opportunity data. In this first phase, the questions and/or comments of one or more potential sponsors are collected and optionally anonymized.

In a second phase following the first phase, the questions and/or comments of one or more potential sponsors are presented to the affected party, e.g. to the lawyer associated with or belonging to the affected party. The affected party will prepare answers to the raised questions and/or clarifications of the opportunity data if necessary and will store and publish the asked questions together with the prepared answers and clarifications together with the opportunity data.

It may further be provided that an interrupt as described above can be caused already during the Q & A process thereby allowing intervention before the bookbuilding process starts.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention enable sponsor data items to be provided anonymously e.g. by different sponsoring parties. Furthermore, existing sponsor data items may be adapted in real time wherein all previously generated bid participation quotes of other valid sponsor data items can be immediately considered. Particularly, the bid participation quotes of other valid sponsor data items can be considered in an anonymous manner so that the adapting of the bid participation quote can be made in knowledge of the bid participation quotes of previously obtained sponsor data items but without exposing the source of the sponsor data item. These are functions which are inherently computer-implemented and which could not be performed manually or mentally by a human.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A computer-implemented method for matching opportunity data defining an offer for participation in a planned legal action and at least one sponsor data item defining a participation offer from a sponsoring party to participate in prosecution of a planned legal action, comprising the steps of:
Providing opportunity data, stored in an opportunity database, about the planned legal action from an affected party to a computer, wherein the opportunity data is defined by prosecution resources needed to prosecute the planned legal action, a best possible result that is achieved by a full of success of the prosecution and an ask participation quote,
Obtaining, at the computer, a plurality of sponsor data items each including a participation offer in a bookbuilding process stored in a database wherein the participation offers each include a bid participation quote and an amount of sponsoring resources;
Using the computer, selecting one or more participation offers from the obtained participation offers depending on the ask participation quote, the prosecution resources, as well as on the bid participation quotes and the sponsoring resources of each of the plurality of the sponsor data items, wherein the participation offers are selected from the obtained bid participation offers as those which include associated sponsoring resources which sum up to at least the prosecution resources, wherein the participation offers are further selected so that
the bid participation quotes associated with the selected participation offers are equal or lower than the ask participation quote; and
the total of the sponsoring resources associated with all of the selected participation offers is equal or higher than the prosecution resources; and
Using the computer to automatically match the sponsor data items associated with the selected one or more participation offers with the opportunity data, with the aim to enable the prosecution of the defined legal action to be prosecuted.

2. The method according of claim 1, wherein the obtaining, at the computer, of the plurality of sponsor data items includes obtaining at least one of sponsor data items in view of the previously obtained sponsor data items, wherein particularly only the bid participation quote and the sponsoring resources associated to each existing sponsor data item are indicated or revealed, wherein particularly the identities of the sponsoring parties are not disclosed.

3. The method of claim 2, wherein the participation offers are selected from at least one of:
the obtained participation offers as those which have the lowest bid participation quotes which are equal or lower than the ask participation quote; and
the obtained bid participation offers as those which include associated sponsoring resources which sum up to at least the prosecution resources.

4. The method of claim 3, wherein if more than one of the obtained participation offers of the lowest bid participation quote are selectable only the earliest participation offer is considered so that concurring participation offers will be handled on a first-come, first-served base.

5. The method of claim 4, wherein the selecting of the participation offers is performed in the computer after the bookbuilding process has been terminated, particularly not before the affected party indicates an end of the method for matching or after a predetermined time period after providing the planned legal action, wherein the participation offers are selected so that
the bid participation quotes associated with the selected participation offers are equal or lower than the ask participation quote, and
the total of the sponsoring resources associated with all of the selected participation offers is equal or higher than the prosecution resources.

6. The method of claim 5, wherein the planned legal action is further defined by a detailed description of facts, the best possible result of the planned legal action, prosecution resources, and ask participation quote offered by the affected party.

7. The method of claim 1, wherein the best possible result after successfully prosecuting the planned legal action is an amount of resources, such as material, goods or money, the obtaining of an allowance claim or a prohibition claim, a clarification of a fundamental legal issue wherein particularly the best possible result comprises one of an amount of resources, obtaining of an allowance claim or a prohibition claim, and a clarification of a fundamental legal issue.

8. The method of claim 1, wherein the prosecution resources, the sponsoring resources and/or the best possible result are converted into a resource unit in the computer, such as a currency or blockchain-based token or a kind of unit which make the different items of prosecution resources, the sponsoring resources and/or the best possible result resources comparable.

9. The method of claim 13, wherein the ask participation quote is increased during the bookbuilding process, particularly in view of the obtained bid participation quotes and associated sponsoring resources of the sponsor data items, and/or
wherein the bid participation quote of a sponsor data item is decreased during the bookbuilding process, particularly in view of the obtained bid participation quotes and associated sponsoring resources of the obtained other sponsor data items.

10. The method of claim 1, wherein it is queried to confirm the ask participation quote, wherein after confirmation the opportunity data is stored in a blockchain based repository, and/or,
wherein it is queried to accept the participation offer, wherein after confirmation the opportunity data is stored in a blockchain based repository.

11. The method of claim 1, wherein a share of how each of the selected sponsor data item will be associated with the actual result of the opportunity is defined by the portion of the sponsoring resource of each sponsor data with respect to the required prosecution resources.

12. The method of claim 1, wherein after the bookbuilding process has been finished and the opportunity data and the sponsor data items has been matched, equal participation quotes are applied on the result of the prosecution of the planned legal action according to the highest participation quotes of all considered participation offers.

13. The method of claim 1, wherein the degree of participation of sponsor data items at a planned legal action defined by opportunity data after a termination of prosecution of the planned legal action is resolved; wherein an actual result of the prosecution of a planned legal action is distributed/shared depending on a final participation quote, wherein the final participation quote is particularly defined as the highest participation quote of the selected participation offers.

14. The method of claim 1, wherein an upfront share of the actual result is distributed among the sponsor data items while the remaining part of the result is distributed among the affected party and the sponsoring parties according to the final participation quote.

15. A computer system for matching opportunity data defining an offer for participation in a planned legal action and at least one sponsor data item defining a participation offer to participate in prosecution of a planned legal action, wherein the system is configured to:
receive opportunity data about the planned legal action from an affected party, wherein the opportunity data is stored in an opportunity database and defined by prosecution resources needed to prosecute the planned legal action, a best possible result that is achieved by a full success of the prosecution and an ask participation quote,
obtain a plurality of sponsor data items each including a participation offer in a bookbuilding process stored in a database wherein the participation offers each include a bid participation quote and an amount of sponsoring resources;
select one or more participation offers from the obtained participation offers depending on the ask participation quote, the prosecution resources, as well as on the bid participation quotes and the sponsoring resources of each of the plurality of the sponsor data items, wherein the participation offers are selected from the obtained bid participation offers as those which include associated sponsoring resources which sum up to at least the prosecution resources, wherein the participation offers are further selected so that:
the bid participation quotes associated with the selected participation offers are equal or lower than the ask participation quote; and
the total of the sponsoring resources associated with all of the selected participation offers is equal or higher than the prosecution resources; and
automatically match the sponsor data items associated with the selected one or more participation offers with the opportunity data.

16. The computer system of claim 15, wherein the system is configured to obtain at least one of sponsor data items in view of the previously obtained sponsor data items, wherein particularly only the bid participation quote and the sponsoring resources associated to each existing sponsor data item are indicated or revealed.

17. The computer system of claim 15, wherein the system is configured to provide a query to allow the participation offers to be selected from the obtained participation offers as those which have the lowest bid participation quotes which are equal or lower than the ask participation quote, and/or to provide a query to allow the participation offers to be selected from the obtained bid participation offers as those which include associated sponsoring resources which sum up to at least the prosecution resources.

18. The computer system of claim 15, wherein the system is configured to select the participation offers after the bookbuilding process has been terminated wherein the participation offers are selected so that
the bid participation quotes associated with the selected participation offers are equal or lower than the ask participation quote, and
the total of the sponsoring resources associated with all of the selected participation offers is equal or higher than the prosecution resources.

19. The computer system of claim 15, wherein the system is configured to select the participation offers after the bookbuilding process has been terminated, particularly not before the affected party indicates an end of the method for matching and/or after a predetermined time period after providing the opportunity.

20. The computer system of claim 15, wherein the system is configured to convert the prosecution resources, the sponsoring resources and/or the best possible result into a resource unit, such as a currency or blockchain-based token or a kind of unit which make the different items of prosecution resources, the sponsoring resources and/or the best possible result resources comparable.

21. The computer system of claim 15, wherein the system is configured to issue a notification that the bookbuilding process will be terminated soon.

22. The computer system of claim 15, wherein the degree of participation of sponsor data items at a planned legal action defined by opportunity data after a termination of prosecution of the planned legal action is resolved; wherein the system is configured to distribute/share an actual result of the prosecution of a planned legal action depending on a final participation quote, wherein the final participation quote is particularly defined as the highest participation quote of the selected participation offers.

23. A computer program product comprising a computer usable medium having computer readable program code means embodied in said medium for causing an application program to execute on a computer a computer-implemented method for matching opportunity data defining an offer for participation in a planned legal action and at least one sponsor data item defining a participation offer from a sponsoring party to participate in prosecution of a planned legal action, wherein the application program performs the steps of:
Providing opportunity data stored in an opportunity database about the planned legal action from an affected party to a computer, wherein the opportunity data is defined by prosecution resources needed to prosecute the planned legal action, a best possible result that is achieved by a full success of the prosecution and an ask participation quote,
Obtaining, at the computer, a plurality of sponsor data items stored in a database, and each including a participation offer in a bookbuilding process;
Using the computer, selecting one or more participation offers from the obtained participation offers depending on the ask participation quote, the prosecution resources, as well as on the bid participation quotes and the sponsoring resources of each of the plurality of the sponsor data items, wherein the participation offers are selected from the obtained bid participation offers as those which include associated sponsoring resources which sum up to at least the prosecution resources, wherein the participation offers are further selected so that:
the bid participation quotes associated with the selected participation offers are equal or lower than the ask participation quote; and
the total of the sponsoring resources associated with all of the selected participation offers is equal or higher than the prosecution resources; and
Using the computer to automatically match the sponsor data items associated with the selected one or more participation offers with the opportunity data.
